(19) United States
(12) Patent Application Publication
(10) Pub. No.: US 2015/0262289 A1
(43) Pub. Date: Sep. 17, 2015

(54) Method of Producing a Lifestyle Evaluation Report from User Attribute and Behavior Data by Executing Computer-Executable Instructions Stored On a Non-Transitory Computer-Readable Medium

(71) Applicant: Dean S. Hettesheimer, Cincinnati, OH (US)

(72) Inventor: Dean S. Hettesheimer, Cincinnati, OH (US)

(21) Appl. No.: 14/659,555

(22) Filed: Mar. 16, 2015

Related U.S. Application Data
(60) Provisional application No. 61/953,079, filed on Mar. 14, 2014.

(51) Int. Cl. G06Q 40/00

(52) U.S. Cl. CPC G06Q 40/00

(57) ABSTRACT

A method of producing a lifestyle financial evaluation report from user attribute and behavior data provides a user with a projection of future financial and potential health consequences based on the user's current eating habits and other behaviors. The user's auxiliary consumption habits, such as tobacco and alcohol consumption, are taken into consideration as well. A personalized report is generated containing future projections for financial consequences based on the inputted user information relating to supporting an unhealthy lifestyle.

The current application claims a priority to the U.S. Provisional Patent application Ser. No. 61/953,079 filed on Mar. 14, 2014. The current application is filed on Mar. 16, 2015, whereas Mar. 14, 2015 and Mar. 15, 2015 were on a weekend.

### FIELD OF THE INVENTION

The present invention relates generally to how three lifestyle choices costs an individual's retirement wealth using our financial analysis systems. More specifically, the present invention is a “virtual” lifestyle risk calculator that accounts for a user's current unhealthy eating habits, smoking and alcohol consumption behaviors in order to determine effects on the user's future financial health to wealth statuses, particularly relating to retirement.

### BACKGROUND OF THE INVENTION

Unhealthy eating habits as well as related unhealthy behaviors continue to contribute to rising healthcare costs in recent times. Obesity, often directly linked to unhealthy and excessive eating habits, is one of the largest causes of preventable death worldwide. A person's excess food consumption beyond a healthy requirement contributes to increased financial spending as well as to obesity. Over time, these excess costs accumulate and negatively impact the person's finances. Obesity usually leads to a host of additional health-related issues such as cardiovascular disease, high blood pressure, high blood cholesterol, diabetes, and various types of cancer. Additional unhealthy behaviors such as using tobacco and consuming alcohol also contributes to decreased personal well-being as well as increased financial losses in retirement. The financial costs for tobacco consumption may be exorbitant based on the rate at which a person consumes cigarettes, cigars, dipping tobacco, and other tobacco products, illustrated to the specific brands and their costs. Due to the addictiveness of nicotine, the long-term effects of tobacco usage must also be taken into account. Tobacco usage may contribute to a large number of health-related problems affecting the heart, liver, lungs, and other areas of the body. Similarly, long-term excessive alcohol consumption may eventually lead to alcoholism as well as significant health-related issues such as cardiovascular disease, liver disease, and a host of psychiatric disorders. The present invention seeks to provide users with a means for accurately projecting the future financial consequences brought upon by the continued after tax spending on an unhealthy lifestyle. Conversion to pre-tax dollars, then applying compounding interest, increases our illustrated financial loss.

The present invention is a lifestyle risk calculator that provides a user with a projection of future financial consequences based on the user's current unhealthy eating habits and other behaviors. In the preferred embodiment of the present invention, the lifestyle risk calculator comprises a method that is used to compile a variety of behaviors and financial cost related to the user's unhealthy lifestyle. The lifestyle risk calculator comprises a food cost calculator that allows a user to determine the financial consequences that arise from eating in excess beyond a healthy requirement. The user's tobacco and alcohol consumption is taken into consideration as well. Use of tobacco products such as cigarettes, cigars, and dipping tobacco is accounted for in order to determine the financial consequences related to tobacco use. The specific costs of brands and rate at which the user consumes tobacco are taken into account as well. Alcohol consumption is a third cost factor that is analyzed in a similar manner as tobacco. The user-provided data is utilized to calculate a variety of factors such as the user's basal metabolic rate (BMR); body mass index (BMI), excess weight converted to calories consumed and consumption costs.

The financial risk calculator outputs a personalized report containing future projections for financial consequences based on the inputted user information relating to supporting an unhealthy lifestyle. Following compilation of the user's current unhealthy eating habits and behaviors, the user's income is input into the financial risk calculator in order to determine the user's Federal tax bracket as well as the user's qualified retirement plan benefit specifics, to determine the pre-tax equivalent contribution available. Our calculator takes advantage of all savings enhancements; employer contribution and compounding interest. Various additional factors relating to the user's finances are taken into consideration in order to provide an ideal projection of future retirement savings. The compiled data relating to the user's unhealthy eating habits and behaviors are factored into the ideal projection in order to inform the user of the future financial impact of continuing to support current unhealthy eating habits and behaviors (i.e. detractions from the ideal project of future retirement savings). The user's calculated BMI, BMR, blood pressure, blood cholesterol level, blood glucose level, sleep, dental and additional calculator factors are compared against healthy ranges. The compiled data is also utilized to display the potential risk (i.e. a percentage) for future health risks in the event that the user continues supporting an unhealthy lifestyle. The user is afforded the opportunity to modify inputted values relating to the unhealthy eating habits and behaviors in order to view the impact of lifestyle changes on future finances.

The present invention will educate users about the health and financial consequences of their unhealthy behavior, thus, allowing users to achieve better clinical and financial outcomes and realize savings for retirement in the form of monies that would have been spent to support their unhealthy lifestyle.

### BRIEF DESCRIPTION OF THE DRAWINGS

FIG. 1A is a stepwise flow diagram depicting the overall method of the present invention.

FIG. 1B is a continuation of FIG. 1A.

FIG. 2 is a stepwise flow diagram depicting steps for calculating the projected retirement savings increase from a pre-tax monetary amount.

FIG. 3 is a stepwise flow diagram depicting steps for calculating the caloric overage cost.

FIG. 4 is a stepwise flow diagram depicting alternate steps for calculating the caloric overage cost.

FIG. 5 is a stepwise flow diagram depicting steps for calculating the auxiliary consumption habit cost.

FIG. 6 is a stepwise flow diagram depicting steps for recalculating the projected outcomes on the lifestyle financial evaluation report.

FIG. 7 is a stepwise flow diagram depicting steps for recalculating the projected outcomes on the lifestyle financial evaluation report with adjustable sliders.

FIG. 8 is a stepwise flow diagram depicting steps for displaying acceptability indicators on the lifestyle financial evaluation report.

FIG. 9 is a stepwise flow diagram depicting steps for adjusting the projected retirement savings increase according to a financial wellness incentive.

FIG. 10 is a stepwise flow diagram depicting steps for sending alert messages to the user.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a lifestyle risk evaluation tool that compiles data related to a user's unhealthy eating habits and behaviors in order to provide a projection of future financial consequences in the continuance of an unhealthy lifestyle. The lifestyle risk evaluation tool comprises a method that provides a thorough collection of data relating to the user's current unhealthy lifestyle as well as the user's finances in order to provide an accurate projection. The present invention provides the end user a means to understand the potential future impact of continuing an unhealthy lifestyle in terms of health risks and financial impact, particularly the impact on the end user's retirement savings.

The present invention is presented as a software application executed by a computing device. The computing device may be a desktop computer, a laptop computer, a mobile phone, a tablet, a smart watch, or any other applicable computing device capable of receiving digital inputs, processing the inputs and producing relevant outputs.

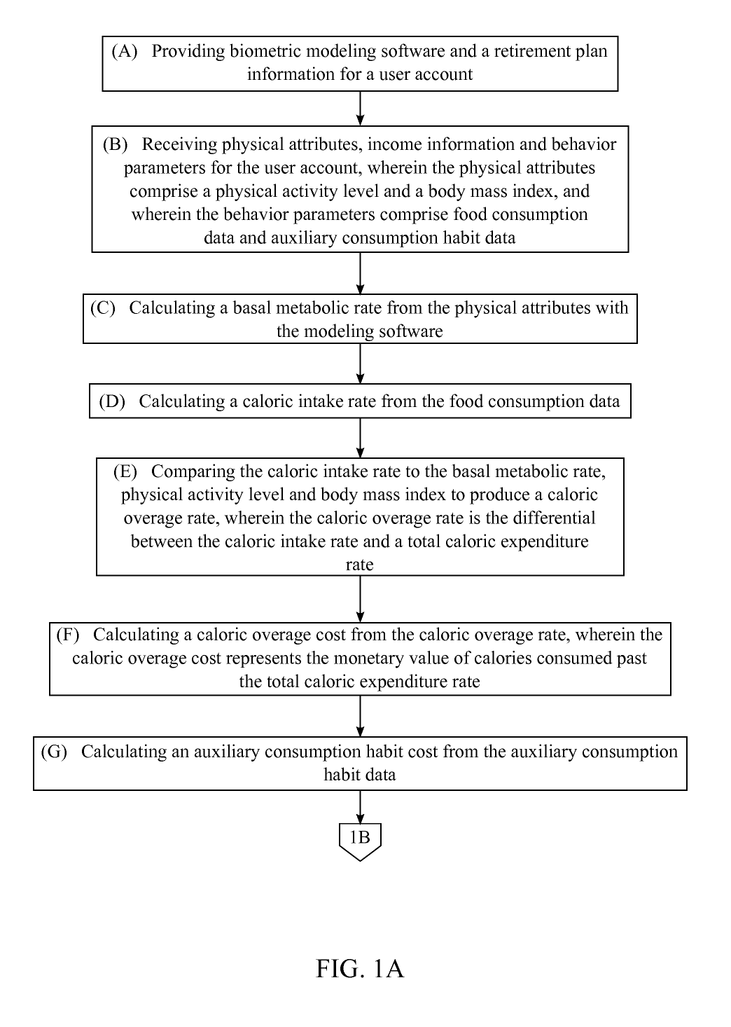

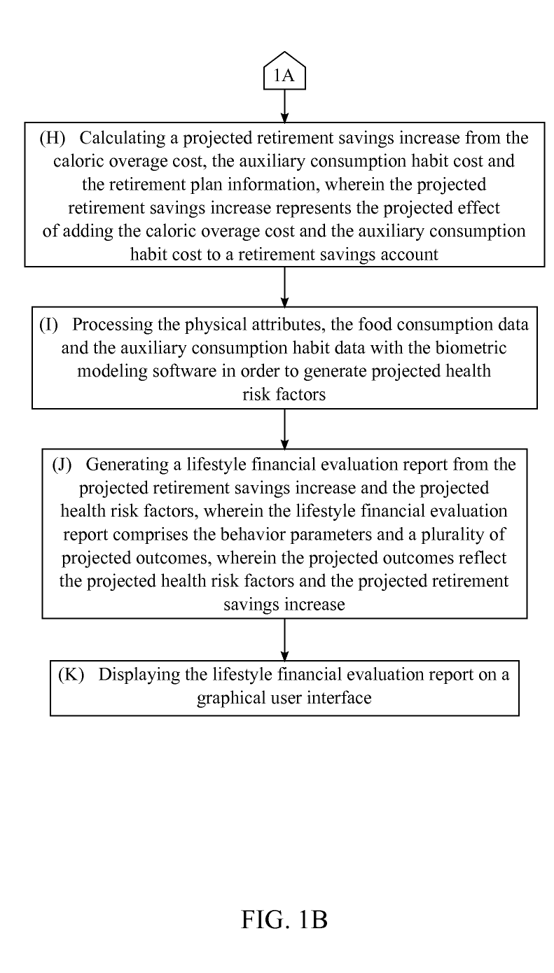

Referring to FIG. 1A, in the software method of the present invention, biometric modeling software is provided, in addition to retirement plan information for a user account. The biometric modeling software is preferably a pre-existing application, set of applications or some other technology which is capable of computing biometric data. The user account is associated with an end user of the present invention, wherein the end user registers the user account with an operating entity of the present invention, which is recorded into a database which interfaces with the software and any necessary hardware of the present invention. The retirement plan information describes the details of the end user's retirement plan, which is utilized to calculate potential additional future retirement savings based on additional funds available from reducing negative habits.

Physical attributes, income information and behavior parameters are received for the user account. The physical attributes comprise attributes such as, but not limited to, gender, height, weight, age, physical activity level, blood pressure, body mass index (BMI), cholesterol, and any other relevant factors. The income information denotes the end user's salary or other level of monetary income.

The behavior parameters comprise, but are not limited to food consumption data and auxiliary consumption habit data. The present invention is primarily focused on evaluating the behavior parameters. The behavior parameters represent any type of data required to ascertain a sufficient picture of current user behavior relevant to caloric intake and other detrimental habits. Auxiliary consumption habits may include, but are not limited to, tobacco intake, alcohol intake, recreational drug intake, or other detrimental habits.

A basal metabolic rate (BMR) is calculated from the physical attributed with the modeling software, and a caloric intake rate is calculated from the food consumption data. Subsequently, the caloric intake rate is compared to the BMR, physical activity level and BMI in order to produce a caloric overage rate. The caloric overage rate represents the differential between the caloric intake rate and a total caloric expenditure rate. The total caloric expenditure rate may be represented as a total daily expenditure rate (TDEE), a well-known metric which denotes an estimate of the amount of calories a person burns per day.

A caloric overage cost is then calculated from the caloric overage rate. The caloric overage cost represents the monetary value of calories consumed past the total caloric expenditure rate, represented in an out-of-pocket cost to the end user. The out-of-pocket cost is significant because the out-of-pocket cost is less than corresponding pre-tax funds, which could have been deposited into a retirement savings account for a greater net gain.

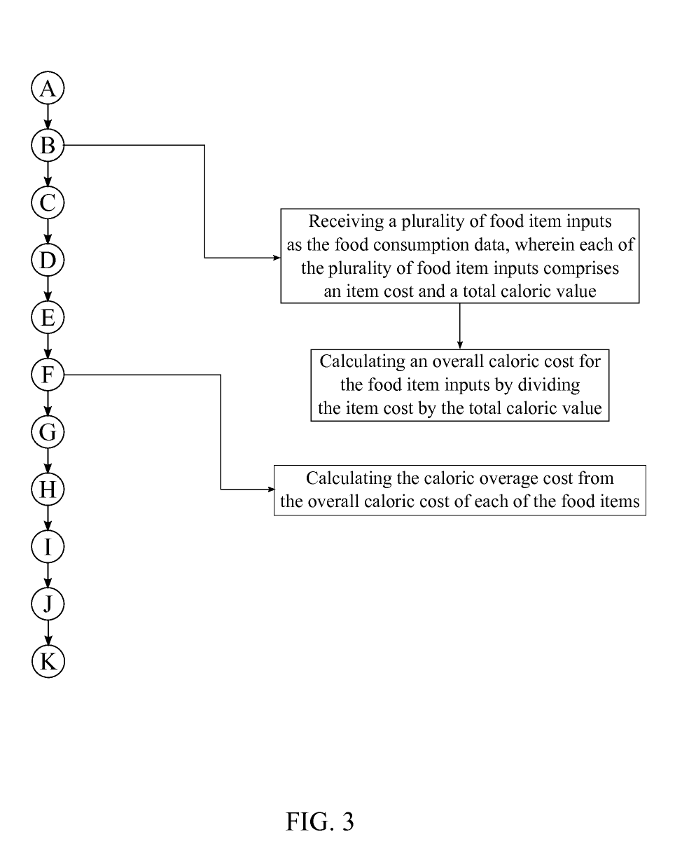

In reference to FIG. 3, in a first embodiment of the present invention, the end user is prompted to manually enter the food consumption data as a plurality of food item inputs. This embodiment may be known as a food cost calculator, or a nutrition diary. Each of the food item inputs represents one food item, such as an apple or a package of chicken. Each food item input comprises an item cost and a total caloric value. An overall caloric cost is calculated for the food item inputs by dividing the item cost by the total caloric value, and the caloric overage cost is calculated from the overall caloric cost of each of the food items. Additionally or alternatively, each food item input may comprise a caloric value per serving and a number of servings consumed, from which the overall caloric cost may be calculated.

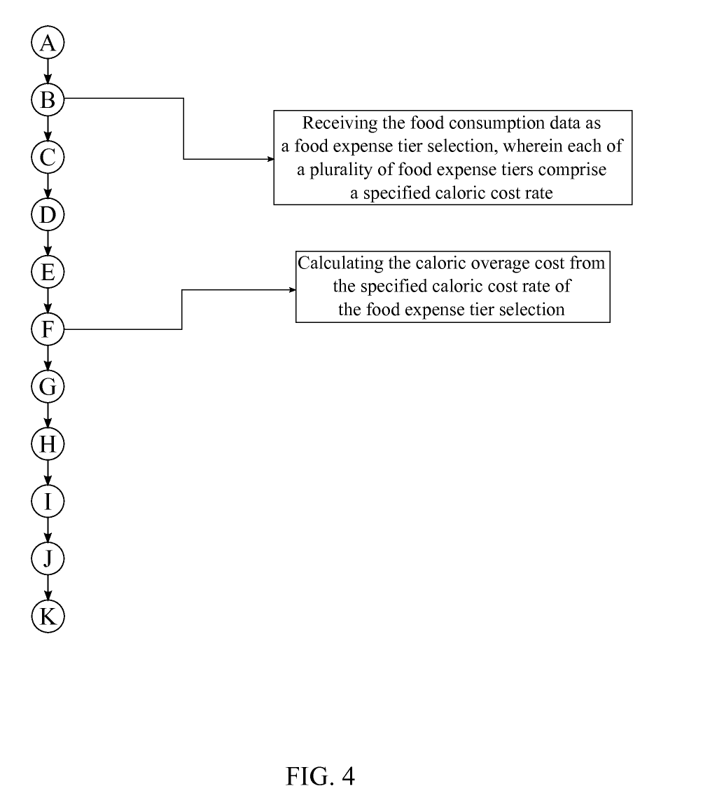

In a second embodiment depicted in FIG. 4, the food consumption data may be received as a food expense tier selection. Each of the plurality of food expense tiers comprises a specified caloric cost rate. For example, a first food expense tier may represent the cheapest possible means of purchasing food, such as purchasing fast food, frozen foods or bulk foods. A second food expense tier may represent a more expensive food purchasing habit, such as eating out at chain restaurants or shopping the perimeter of grocery stores. A third food expense tier may represent the most expensive options, such as shopping at fresh markets, farmers markets, butchers shops, or boutique food shops. The food expense tiers are not limited to the previous examples, however, and additional or alternate food expense tiers may be utilized. In this embodiment the caloric overage cost is calculated from the specified caloric cost rate of the food expense tier selection. The end user may have the option to utilize either the aforementioned first embodiment or the aforementioned second embodiment according to the end user's preference.

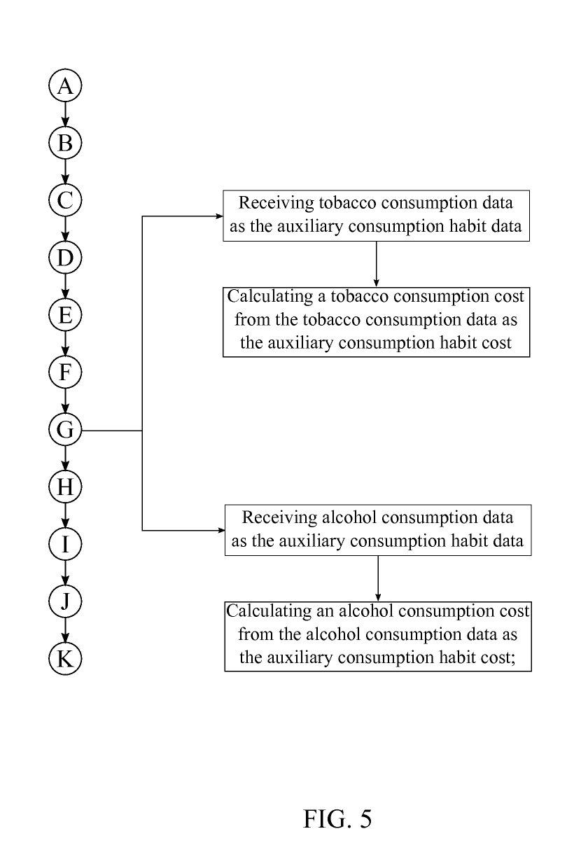

In reference to FIG. 5, an auxiliary consumption habit cost is also calculated from the auxiliary consumption habit data. The specific method for calculating the auxiliary consumption habit cost may vary according to the embodiment of the auxiliary consumption habit.

In one embodiment, the auxiliary consumption habit data is received as tobacco consumption habit data, if applicable, and the tobacco consumption cost is calculated from the tobacco consumption data as the auxiliary consumption habit cost. The end user inputs data related to the rate of their tobacco usage. A variety of tobacco products may be input into the system such as, but not limited to, cigarettes, cigars, dipping tobacco, and other tobacco products. Inputted data relates to the amount of each tobacco product consumed throughout the day as well as the specific categories of the tobacco products. The user may directly input the costs incurred in order to purchase the tobacco products as the costs may vary based on the specific market. Again, as with the food cost calculator, the inputted financial information and consumption rate information is used to determine a tobacco usage cost that is unique to the user. This information is utilized to determine the cost per day, week, month, and year of the user's continued tobacco use.

In another embodiment, the auxiliary consumption habit data is received as alcohol consumption habit data, if applicable, and the alcohol consumption cost is calculated from the alcohol consumption data as the auxiliary consumption habit cost. Alcoholic beverages fall into the three general categories of spirits (liquors), wines, and beers. Because alcoholic beverages may vary greatly in terms of various factors such as the alcohol by volume (ABV) and alcohol proof, the user is required to input data that is relevant to the types of alcohol consumed. The user may input data relating to the rate of his or her alcohol consumption as well as the types and brands of alcohol consumed. The costs of individual servings consumed by the user are inputted in order to determine the alcohol usage cost that is unique the user. As with food and tobacco, the inputted user information is used to determine the cost per day, week, month, and year of the user's continued alcohol use.

In the preferred embodiment of the present invention, the three primary factors of food, tobacco, and alcohol consumption are taken into account. However, in alternate or future embodiments of the present invention, the present invention may incorporate evaluation of additional potentially detrimental such as, but not limited to, coffee consumption, stimulant beverages gambling habits, or recreational drug use.

A projected retirements savings increase is then calculated from the caloric overage cost, the auxiliary consumption habit cost and the retirement plan information, as described in FIG. 1B. The projected retirement savings increase represents the projected effect of adding the caloric overage cost and the auxiliary consumption habit cost to the retirement savings account.

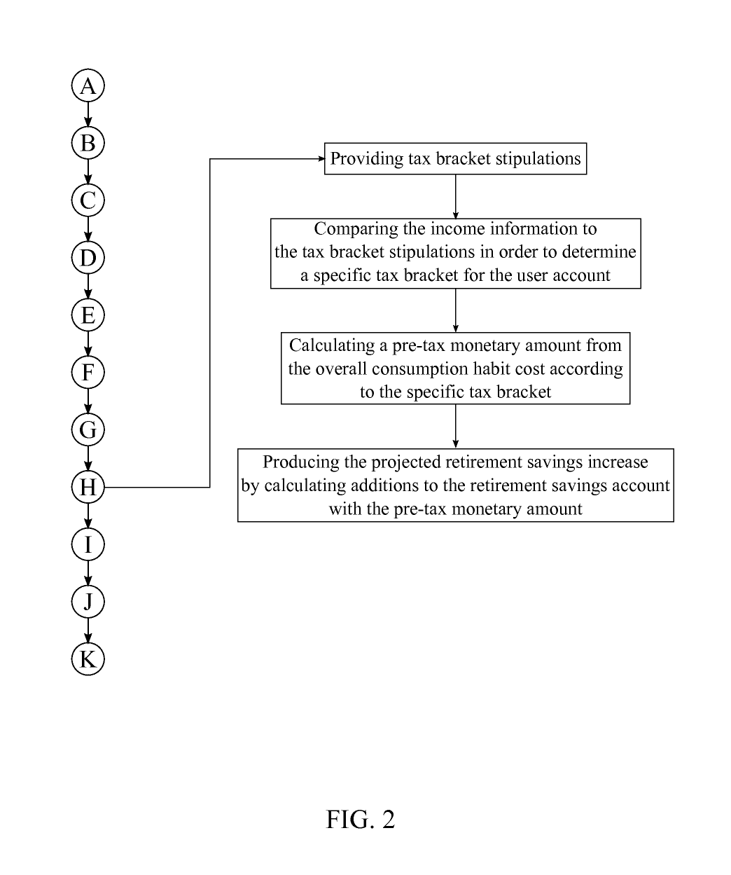

In order to accurately calculate the projected retirement savings increase, tax bracket stipulations are provided as depicted in FIG. 2. The tax bracket stipulations may correspond to federal, state, city, or other governing body tax stipulations. The income information is compared to the tax bracket stipulations in order to determine a specific tax bracket for the user account, and a pre-tax monetary amount is calculated from the caloric overage cost and the auxiliary consumption habit cost according to the specific tax bracket. The projected retirement savings increase is produced by calculating additions to the retirement savings account with the pre-tax monetary amount, according to the specifics of the retirement plan information.

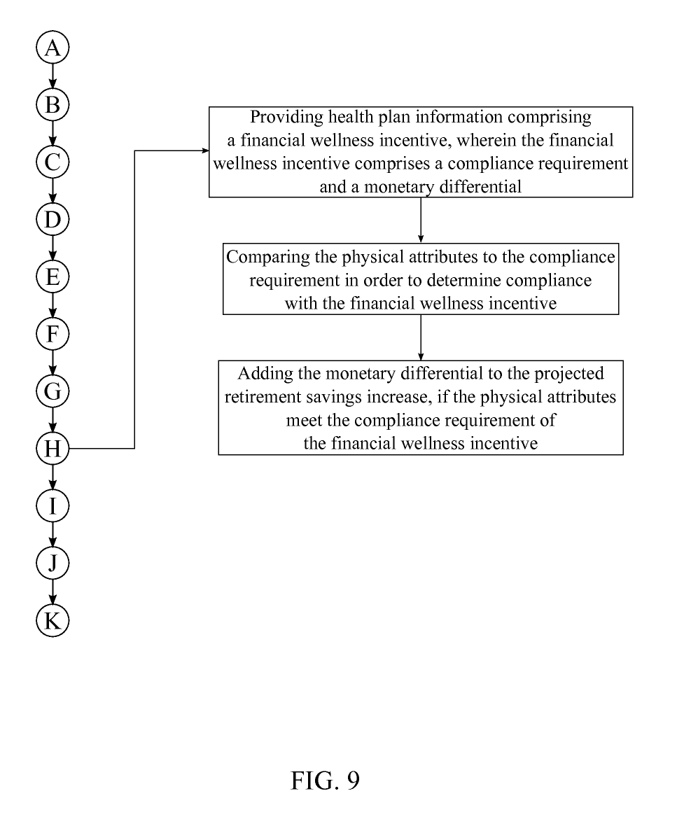

An additional aspect the present invention takes into account is financial wellness incentives as described in FIG. 9. Health plan information may be gathered or received for the user account, potentially either from the user account or from the user's employer, wherein the financial wellness incentive comprises a compliance requirement and a monetary differential. The physical attributes of the user are compared to the compliance requirement in order to determine compliance with the financial wellness incentive. For example, the compliance requirement may stipulate that the user must maintain a BMI within a certain range. If the physical attributes of the user meet the compliance requirement of the financial wellness incentive, the monetary differential is added to the projected retirement savings increase.

The physical attributes, the food consumption data and the auxiliary consumption habit data are then processed with the biometric modeling software in order to generate projected health risk factors. The projected health risk factors represent the potential to develop various health conditions in the future, such as heart disease, diabetes, and other chronic diseases or conditions.

Subsequently, a lifestyle financial evaluation report is generated from the projected retirement savings increase and the projected health risk factors, and the lifestyle financial evaluation report is displayed on a graphical user interface. The lifestyle financial evaluation report comprises the behavior parameters and a plurality of projected outcomes, wherein the projected outcomes reflect the projected health risk factors and the projected retirement savings increase.

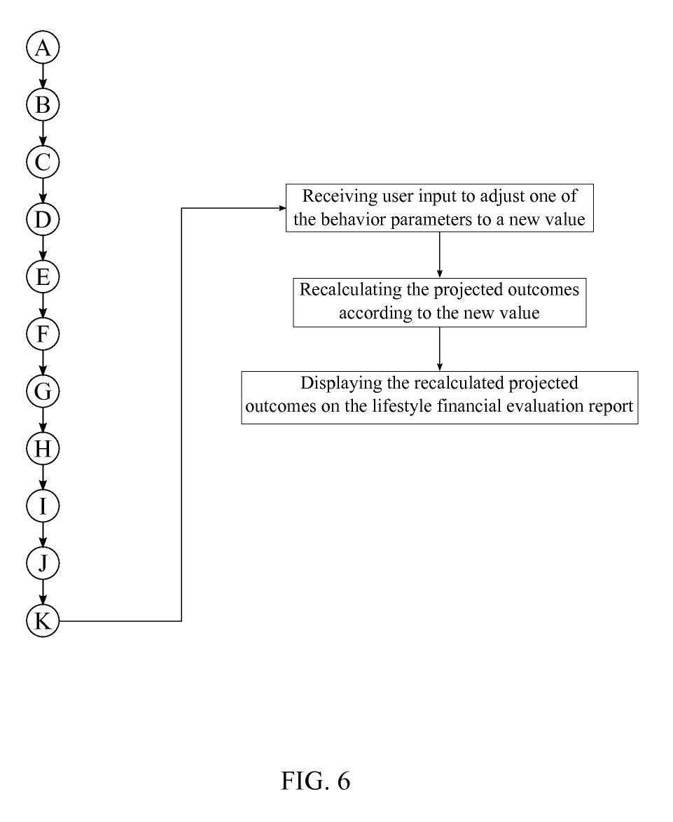

Referring to FIG. 6, in the preferred embodiment of the present invention, upon being presented with the lifestyle financial evaluation report, the user is allowed to adjust parameters on the report in order to experiment with a variety of potential outcomes based on changing their behavior. User input may be received to adjust one of the behavior parameters to a new value. The projected outcomes are then immediately recalculated according to the new value, and the recalculated projected outcomes are then displayed on the lifestyle financial evaluation report.

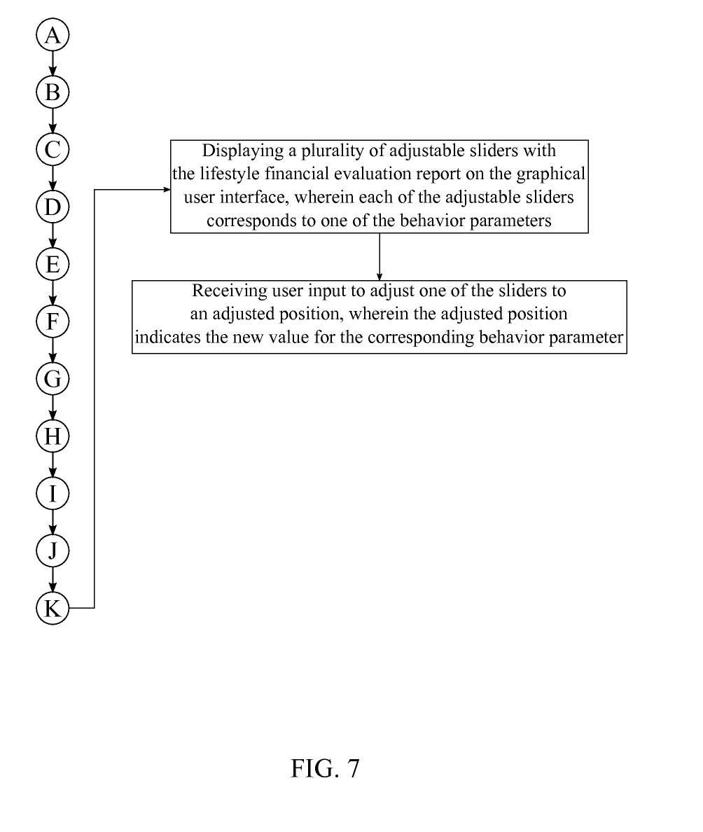

In the preferred embodiment of the present invention as shown in FIG. 7, a plurality of adjustable sliders are displayed on the lifestyle financial evaluation report in order to allow the user to experiment with adjusting the behavior parameters. Each of the adjustable sliders corresponds to one of the behavior parameters. User input is received to adjust one of the sliders to an adjusted position, wherein the adjusted position indicates the new value for the corresponding behavior parameter. The projected outcomes are correspondingly updated.

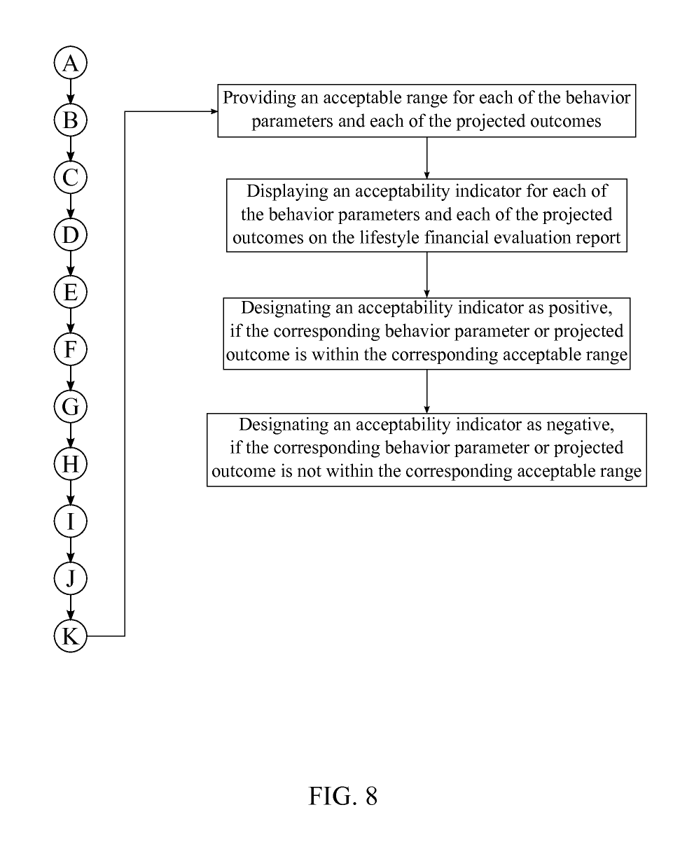

In reference to FIG. 8, the present invention preferably offers user engagement by providing visual acceptability indicators for the behavior parameters and projected outcomes on the lifestyle financial evaluation report. As such, an acceptable range may be provided for each of the behavior parameters and each of the projected outcomes. Alternatively, only one or some of the behavior parameters and projected outcomes may be evaluated in this manner. In the preferred embodiment, an acceptability indicator is displayed for each of the behavior parameters and each of the projected outcomes on the lifestyle financial evaluation report. An acceptability indicator is designated as positive if the corresponding behavior parameter or projected outcome is within the corresponding acceptable range. Conversely, an acceptability indicator is designated as negative if the corresponding behavior parameter or projected outcome is not within the corresponding acceptable range. Examples of acceptability indicators may include, but are not limited to, the color green for positive and the color red for negative. The acceptability indicators may also fluctuate on the color spectrum according to the magnitude of the acceptability of a behavior parameter or projected outcome. For example, a neutral acceptability indicator may appear yellow or orange. The more positive an acceptability indicator, the closer its color is to green. The more negative an acceptability indicator, the closer its color is to red. The aforementioned description of acceptability indicators is provided solely as an example embodiment and is in no way intended to limit the scope of the acceptability indicators.

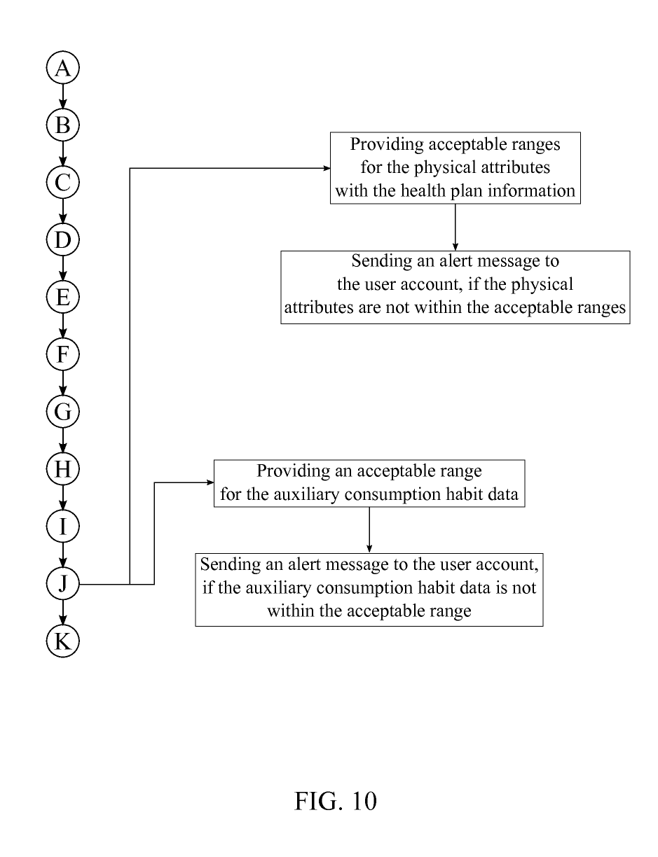

Additionally, the present invention may provide alerts, reminders or updates about the current state of the user's behavior parameters and projected outcomes to facilitate user engagement, as described in FIG. 10. To this end, acceptable ranges may be provided for the physical attributes with the health plan information. An alert message may be sent to the user account if the physical attributes are not within the acceptable ranges. Other stipulations for triggering an alert message may include, but are not limited to, recognizing that the user account has been inactive for a specified length of time.

Similarly, an acceptable range may be provided for the auxiliary habit consumption data, and an alert message may be sent to the user account if the auxiliary consumption habit data is not within the acceptable range. For example, the present invention may send a warning message to the user account if the auxiliary habit consumption data indicates that the user consumes a specific number of alcoholic drinks per day over a threshold limit.

The present invention provides a service that is unique compared to other competitors in this field. The present invention is able to calculate the costs of unhealthy behaviors to the user. The present invention is able to achieve this by calculating costs of unhealthy habits, such as drinking and smoking, by processing the user's input data on these behaviors. These costs are then transformed to show the user pre-tax contributions illustrated as new qualified retirement plans, HSA or IRA contributions. This provides users with an idea of the actual costs associated with their unhealthy habits, along with savings for retirement they are forfeiting because of these behaviors. This correlation has not been utilized and calculated by health calculator previously, leading to a major competitive advantage over other health calculators. The present invention is preferably platform and vendor agnostic, and is provided as a software bundle with an application programming interface in order to be able to be used on any available platform.

Although the invention has been explained in relation to its preferred embodiment, it is to be understood that many other possible modifications and variations can be made without departing from the spirit and scope of the invention as hereinafter claimed.

What is claimed is:

1. A method of producing a lifestyle financial evaluation report from user attribute and behavior data by executing computer-executable instructions stored on a non-transitory computer-readable medium comprises the steps of:
providing biometric modeling software;
providing retirement plan information for a user account;
receiving physical attributes, income information and behavior parameters for the user account, wherein the physical attributes comprise a physical activity level and a body mass index, and wherein the behavior parameters comprise food consumption data and auxiliary consumption habit data;
calculating a basal metabolic rate from the physical attributes with the modeling software;
calculating a caloric intake rate from the food consumption data;
comparing the caloric intake rate to the basal metabolic rate, physical activity level and body mass index to produce a caloric overage rate, wherein the caloric overage rate is the differential between the caloric intake rate and a total caloric expenditure rate;
calculating a caloric overage cost from the caloric overage rate, wherein the caloric overage cost represents the monetary value of calories consumed past the total caloric expenditure rate;
calculating an auxiliary consumption habit cost from the auxiliary consumption habit data;
calculating a projected retirement savings increase from the caloric overage cost, the auxiliary consumption habit cost and the retirement plan information, wherein the projected retirement savings increase represents the projected effect of adding the caloric overage cost and the auxiliary consumption habit cost to a retirement savings account;
processing the physical attributes, the food consumption data and the auxiliary consumption habit data with the biometric modeling software in order to generate projected health risk factors;
generating a lifestyle financial evaluation report from the projected retirement savings increase and the projected health risk factors, wherein the lifestyle financial evaluation report comprises the behavior parameters and a plurality of projected outcomes, wherein the projected outcomes reflect the projected health risk factors and the projected retirement savings increase; and
displaying the lifestyle financial evaluation report on a graphical user interface.

2. A method of producing a lifestyle financial evaluation report from user attribute and behavior data by executing computer-executable instructions stored on a non-transitory computer-readable medium as claimed in claim 1 comprises the steps of:
providing tax bracket stipulations;
comparing the income information to the tax bracket stipulations in order to determine a specific tax bracket for the user account;
calculating a pre-tax monetary amount from the overall consumption habit cost according to the specific tax bracket; and
producing the projected retirement savings increase by calculating additions to the retirement savings account with the pre-tax monetary amount.

3. A method of producing a lifestyle financial evaluation report from user attribute and behavior data by executing computer-executable instructions stored on a non-transitory computer-readable medium as claimed in claim 1 comprises the steps of:
receiving a plurality of food item inputs as the food consumption data, wherein each of the plurality of food item inputs comprises an item cost and a total caloric value;
calculating an overall caloric cost for the food item inputs by dividing the item cost by the total caloric value; and
calculating the caloric overage cost from the overall caloric cost of each of the food items.

4. A method of producing a lifestyle financial evaluation report from user attribute and behavior data by executing computer-executable instructions stored on a non-transitory computer-readable medium as claimed in claim 1 comprises the steps of:
receiving the food consumption data as a food expense tier selection, wherein each of a plurality of food expense tiers comprise a specified caloric cost rate; and
calculating the caloric overage cost from the specified caloric cost rate of the food expense tier selection.

5. A method of producing a lifestyle financial evaluation report from user attribute and behavior data by executing computer-executable instructions stored on a non-transitory computer-readable medium as claimed in claim 1 comprises the steps of:
receiving tobacco consumption data as the auxiliary consumption habit data; and
calculating a tobacco consumption cost from the tobacco consumption data as the auxiliary consumption habit cost.

6. A method of producing a lifestyle financial evaluation report from user attribute and behavior data by executing computer-executable instructions stored on a non-transitory computer-readable medium as claimed in claim 1 comprises the steps of:
receiving alcohol consumption data as the auxiliary consumption habit data; and
calculating an alcohol consumption cost from the alcohol consumption data as the auxiliary consumption habit cost.

7. A method of producing a lifestyle financial evaluation report from user attribute and behavior data by executing computer-executable instructions stored on a non-transitory computer-readable medium as claimed in claim 1 comprises the steps of:
receiving user input to adjust one of the behavior parameters to a new value;
recalculating the projected outcomes according to the new value; and
displaying the recalculated projected outcomes on the lifestyle financial evaluation report.

8. A method of producing a lifestyle financial evaluation report from user attribute and behavior data by executing computer-executable instructions stored on a non-transitory computer-readable medium as claimed in claim 7 comprises the steps of:
displaying a plurality of adjustable sliders with the lifestyle financial evaluation report on the graphical user interface, wherein each of the adjustable sliders corresponds to one of the behavior parameters; and
receiving user input to adjust one of the sliders to an adjusted position, wherein the adjusted position indicates the new value for the corresponding behavior parameter.

9. A method of producing a lifestyle financial evaluation report from user attribute and behavior data by executing computer-executable instructions stored on a non-transitory computer-readable medium as claimed in claim 1 comprises the steps of:
providing an acceptable range for each of the behavior parameters and each of the projected outcomes;
displaying an acceptability indicator for each of the behavior parameters and each of the projected outcomes on the lifestyle financial evaluation report;
designating an acceptability indicator as positive, if the corresponding behavior parameter or projected outcome is within the corresponding acceptable range; and
designating an acceptability indicator as negative, if the corresponding behavior parameter or projected outcome is not within the corresponding acceptable range.

10. A method of producing a lifestyle financial evaluation report from user attribute and behavior data by executing computer-executable instructions stored on a non-transitory computer-readable medium as claimed in claim 1 comprises the steps of:
providing health plan information comprising a financial wellness incentive, wherein the financial wellness incentive comprises a compliance requirement and a monetary differential;
comparing the physical attributes to the compliance requirement in order to determine compliance with the financial wellness incentive; and
adding the monetary differential to the projected retirement savings increase, if the physical attributes meet the compliance requirement of the financial wellness incentive.

11. A method of producing a lifestyle financial evaluation report from user attribute and behavior data by executing computer-executable instructions stored on a non-transitory computer-readable medium as claimed in claim 1 comprises the steps of:
providing acceptable ranges for the physical attributes with the health plan information; and
sending an alert message to the user account, if the physical attributes are not within the acceptable ranges.

12. A method of producing a lifestyle financial evaluation report from user attribute and behavior data by executing computer-executable instructions stored on a non-transitory computer-readable medium as claimed in claim 1 comprises the steps of:
providing an acceptable range for the auxiliary consumption habit data; and
sending an alert message to the user account, if the auxiliary consumption habit data is not within the acceptable range.
